(19) United States
(12) Patent Application Publication
(10) Pub. No.: US 2026/0202354 A1
(43) Pub. Date: Jul. 16, 2026

(54) FLUID DETECTION APPARATUS AND A METHOD OF DETECTING THE PRESENCE OF FLUID

(71) Applicant: Logistics and Supply Chain MultiTech R&D Centre Limited, Pok Fu Lam (HK)

(72) Inventors: Chun Hung Cheng, Pok Fu Lam (HK); Ho Lam, Pok Fu Lam (HK); Wing Pong Ngai, Pok Fu Lam (HK); Ka Leung Lau, Pok Fu Lam (HK)

(21) Appl. No.: 19/017,982

(22) Filed: Jan. 13, 2025

(51) Int. Cl. G01N 22/04; G01M 3/38

(52) U.S. Cl. CPC G01N 22/04; G01M 3/38

(57) ABSTRACT

A fluid detection apparatus for detecting the presence of fluid including a sensor arranged to resonate at a resonant frequency; a detector module arranged to detect the resonant frequency of the sensor; wherein the resonate frequency of the sensor is variable in response to the amount of the fluid proximate to the sensor. Disclosed also is a method of detecting the presence of fluid.

### TECHNICAL FIELD

The present invention relates to a fluid detection apparatus and a method of detecting the presence of fluid, and particularly, but not exclusively, to a fluid detection apparatus for detecting fluid leakage from a fluid channel and a method of detecting fluid leakage from a fluid channel.

### BACKGROUND

Water leakage can have significant impacts on daily life, such as the landslide that frequently occurred in Hong Kong. Flooding of the discharge conduit leads to water leakage into the soil, causing soil erosion and triggering landslides.

On 8 Sep. 2023, a landslide resulted in giant boulders tumbling down a section of Yiu Hing Road, completely covering about 50 meters of the road with mud and rocks. The rubble from the fallen rocks stood up to three meters high, with the largest rock being the size of a minivan.

The detection and identification of water leakage is important for crisis management, preventative maintenance and safety considerations. These water leakages can be understood as root cause and triggering events of soil erosion. However, water leakage detection for discharge conduit is not an easy task. The major challenges for the discharge conduit include long-range detection, non-straight geometry, difficulty in installing sensors, the need for low power consumption in the battery supply system, and the requirement to operate in extreme weather or environments.

To detect the water leakage, one way would be for inspectors to visit the discharge conduit and perform water leakage tests in situ. This is a periodic rather than continuous monitoring of the water leakage. It is not ideal for being time and resources consuming. A frequent checking of water leakage is not practical.

The invention seeks to eliminate or at least to mitigate such shortcomings by providing a new or otherwise improved fluid detection system and a related method of detecting the presence of fluid leaking from a fluid channel.

### SUMMARY OF THE INVENTION

In accordance with a first aspect of the present invention, there is provided a fluid detection apparatus for detecting the presence of fluid, comprising:
a sensor arranged to resonate at a resonant frequency;
a detector module arranged to detect the resonant frequency of the sensor;
   wherein the resonate frequency of the sensor is variable in response to the amount of the fluid proximate to the sensor.

In accordance with the first aspect, the change in the resonate frequency is proportional to surface area of the sensor in contact with the fluid.

In accordance with the first aspect, the sensor includes a predetermined length and the change in the resonate frequency is proportional to the length of the sensor in contact with the fluid.

In accordance with the first aspect, the sensor is extended from the detector module.

In accordance with the first aspect, the detector module is fluidly isolated from the fluid channel.

In accordance with the first aspect, the resonate frequency detected by the detector module is indicative of fluid leakage from a fluid channel.

In accordance with the first aspect, the detector module is arranged to generate one or more information output associated with the fluid leakage from the fluid channel.

In accordance with the first aspect, further including a receiving module in signal communication with the detector module thereby receiving information output associated with the fluid leakage from the fluid channel.

In accordance with the first aspect, the receiving module in wireless communication with the detector module.

In accordance with the first aspect, the receiving module further comprises a database storing a plurality of reference dataset correlating the level of fluid leakage to various resonate frequencies.

In accordance with the first aspect, the receiving module further comprises a solar panel arranged to harvest solar energy thereby supplying power to the analyzing module.

In accordance with the first aspect, further including an analyzing module in signal communication with the receiving module thereby interpreting the information output associated with the fluid leakage in the fluid channel.

In accordance with the first aspect, the analyzing module is in LTE communication with the receiving module.

In accordance with the first aspect, further comprising a housing for containing at least one of the sensor and the detector module.

In accordance with the first aspect, the sensor comprises an antenna sensor.

In accordance with the first aspect, the antenna sensor comprises a RF antenna.

In accordance with the first aspect, the detector module is located proximate to the sensor thereby measuring the reflected power of the antenna sensor.

In accordance with the first aspect, the detector module comprises an antenna circuit arranged to detect the resonance frequency of the antenna sensor.

In accordance with the first aspect, the fluid channel is a discharge conduit.

In accordance with a second aspect of the present invention, there is provided a method of detecting the presence of fluid, comprising the steps of:
positioning a sensor proximate to the fluid channel;
detecting the resonate frequency generated by the sensor, the resonant frequency being variable in response to the amount of the fluid proximate to the sensor; and
determining the fluid leakage from the fluid channel based on the detected resonate frequency of the sensor.

### BRIEF DESCRIPTION OF THE DRAWINGS

Embodiments of the present invention will now be described, by way of example, with reference to the accompanying drawings in which:

FIG. 1 is a schematic diagram of a fluid detection apparatus in accordance with one example embodiment of the present invention.

FIG. 2 is an enlarged view showing the isolated fluid detection apparatus of FIG. 1 in further details.

FIG. 3 is a schematic diagram showing the workflow of a fluid detection apparatus in accordance with another example embodiment of the present invention.

FIG. 4 is a schematic diagram of a fluid detection system in accordance with yet another example embodiment of the present invention.

### DETAILED DESCRIPTION OF THE PREFERRED EMBODIMENTS

Without wishing to be bound by theory, the inventors have discovered that while it is possible to install sensors for the detection of water leakage, drainage conduit are not straight in geometry and difficult to install the sensors there. Existing water sensor also requires high power consumption for battery supply system. Also, those water sensors would be exposed to outdoor and may not be durable in extreme weather or environment.

The present invention relates to a water leakage detection for discharge conduit. By having an antenna placed in drainage channels and when water fills up, it would change the medium which surrounds the antenna. This would change the frequency of the signal that is emitted by the antenna, in turn change the resonance of the antenna. This can be detected by the antenna circuit to measure how much water has submerged the antenna.

In one example embodiment in accordance with the present invention, the fluid detection system may achieve several objectives so as to overcome the aforementioned shortcomings. The objectives include achieving long-range detection, ensuring low power consumption, utilizing low-cost sensors, and maintaining operational functionality in extreme weather or environments.

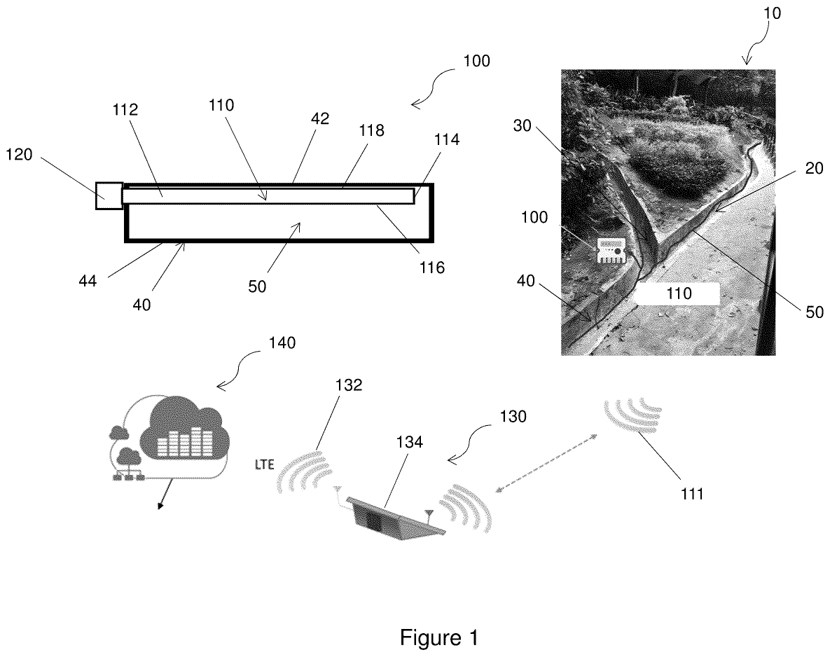

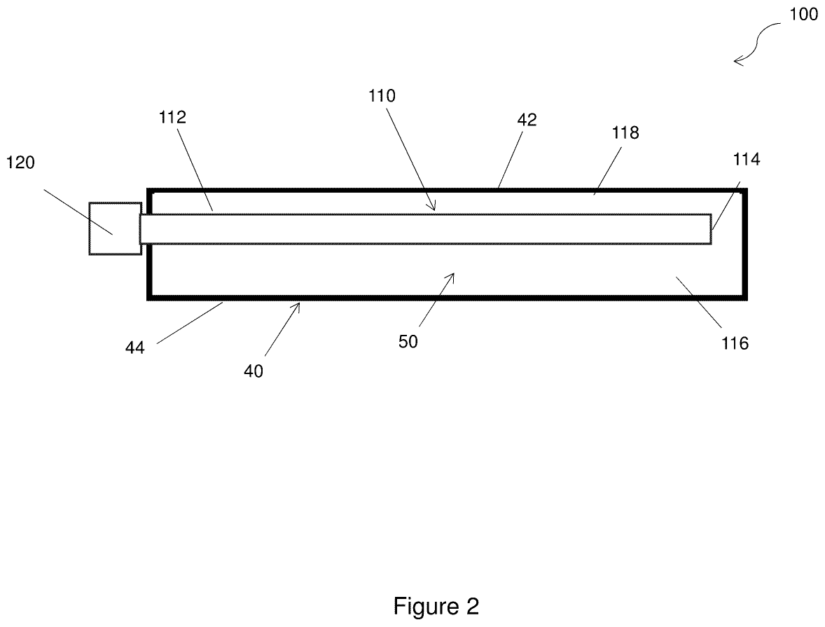

Referring to FIGS. 1 and 2, there is shown an embodiment of a fluid detection apparatus 100 for detecting the presence of fluid 50, comprising: a sensor 110 arranged to resonate at a resonant frequency; a detector module 120 arranged to detect the resonant frequency of the sensor 110; wherein the resonate frequency of the sensor 110 is variable in response to the amount of the fluid 50 proximate to the sensor 110.

The fluid detection apparatus 100 is configured to detect the presence of fluid 50 in a fluid channel 10. The fluid channel 10 here may be a drainage conduit extending along a mid-mountain for discharging the rainwater from the upstream towards one or more storage tanks at the midstream which are normally located on the underground. The water may be filtered and then supplied for household usage. The fluid channel 10 includes but not limited to drainage conduit, and may also include pipes, water pump system etc. The fluid 50 includes but not limited to water e.g., flesh water, sea water, wastewater and may also include other forms of liquid which may interfere the frequency of an antenna.

In one example drainage conduit system 10 as shown in FIG. 1, one or more smaller drainage conduits 20, 30 may collect the rainwater from the uphill and converge to form a main drainage conduit 40. These drainage conduits 20, 30 and 40 are slightly sloped so as to provide enough inclination for discharging the water to a lower water level.

In the fluid detection apparatus 100 as shown in this example embodiment, there is a provided a sensor 110 which is capable of resonating at different frequencies. The resonant frequency of the sensor 110 varies in relation to the fluid 50 filled around the sensor 110 i.e., the water leakage of the drainage conduit 40 where detection is desired. In other words, the sensor 110 resonates at a frequency that reflects or depends on the water content about the sensor 110. In a preferred embodiment, the sensor 110 is an antenna sensor e.g., Radio frequency (RF) antenna which is an electronic device with dual functionality for communicating and sensing. The advantage of using an antenna sensor 110 is that it has a minimum number of components. It is space efficient and also has low energy consumption. A change in the resonant frequency of the sensor 110 reflects the presence of a water leakage from the drainage conduit 40 or at least an overflow of water within the drainage conduit 40.

The resonant frequency of the sensor 110 is detected by a detector module 120 located in proximity to the sensor 110 which is an antenna circuit. In a preferred embodiment, the detector module 120 is placed on one end of the sensor 110 to form an integrated module. The detector module 120 is a frequency detector that detects and captures the resonant frequency of the sensor 110. The detected and captured frequency is then transmitted to a receiving module 130. Any changes in the resonant frequency will also be detected, captured and transmitted to the receiving module 130.

The receiving module 130 is in signal communication with the detector module 120 via wireless communication technology such as Long Range (LoRa) that offers low power consumption and may act as a terminal. The detector module 120 transmits all the detected resonant frequencies to the receiving module 130. An analyzing device which is preferably in the form of an analyzing module 140 is in communication with the receiving module 130 via wireless communication technology 132 such as LTE (Long-Term Evolution). The analyzing module 140 is pre-equipped with reference information for interpretation of the output from the receiving module 130. The detected frequencies are compared with the pre-equipped reference information so as to come to a conclusion on the presence of water leakage from the drainage conduit 40 and the magnitude of the water leakage from the drainage conduit 40.

In this example embodiment, the receiving module 130 may be powered by an energy storage. Alternatively, the receiving module 130 may include a solar panel 134 configured to harvest solar energy and convert the harvested solar energy into electrical energy so as to be stored in the energy storage. The energy storage may be used to power the receiving module 130 or other components of the fluid detection apparatus 100 such as the sensor 110. The sensor 110 may also include a solar panel (not shown) on the exposed surface so as to harvest solar energy for powering the sensor 110.

Preferably, the sensor 110 is extending from a base 112 for a predetermined length and form a tip 114 at the far end. The sensor 110 is placed at the upper inner surface 42 of the discharge conduit 40. The sensor 110 has a lower engagement surface 116 arranged to face a lower inner surface 44 of the drainage conduit 40. The sensor 110 also has an upper engagement surface 118 arranged to face away from the lower inner surface 44 of the drainage conduit 40. In some scenario where the fluid channel is enclosed, the upper engagement surface 118 would face the upper inner surface 42 of the enclosed fluid channel. The detector module 120 is fixed to the sensor 110 on another surface thereof, which is on the opposite side to that of the tip 114.

The aforesaid components of the fluid detection apparatus 100 may be contained in a housing (not shown). The housing may include an opening support which acts as a stand for supporting and affixing the sensor 110 on the detector module 120. The housing may sealingly enclose the sensor 110 and the detector module 120 is isolated from the sensor 110 and the fluid surrounding the sensor 110, so that detection is possible and will continue even under extreme weather or adverse environmental conditions.

There may also be provided a further housing (not shown) for sealingly enclosing the detector module 120 separately to avoid the ingress of water. The housing may contain one or more pins so that the fluid detection apparatus 100 may be secured into the soil. Alternatively, the detector module 120 may be enclosed by a housing made of rigid materials such that the housing may be inserted into the soil directly.

Optionally, there may also be provided a layer of insulator (not shown) on the engagement surfaces 116, 118 such that the sensor 110 is in engagement or connected with the fluid via at least the insulator layer. The insulator may be made of materials with good water absorption ability so as to increase the sensitivity of the sensor 110.

As a particular example where the sensor 110 is not in contact with any water leaking from the discharge conduit 40, in normal circumstances the sensor 110 resonates at a first frequency. When there is an overflow of water in the drainage conduit 40 and water leakage from the discharge conduit 40 begins, the sensor 110 will resonate in a different second frequency. The difference in resonant frequency indicates the escape of water from the discharge conduit 40, for example water may contact the soil and thus result in the erosion of the soil. The magnitude of the frequency change may be useful to indicate the water leakage from the drainage conduit 40 and the significancy of the water leakage from the drainage conduit 40. In general, the resonant frequency of the sensor 110 increases with an increased amount of water proximate to the sensor 110.

Preferably, the fluid detection apparatus 100 may be positioned at the upper inner surface 42 of discharge conduit 40 with a slight inclination such that the tip 114 is oriented towards the lower inner surface 44 of the drainage conduit 40. As the water leaking from the drainage conduit 40 increases, the length of the sensor 110 dipped in water would also increase. Thus, the change in the resonate frequency is proportional to the length of the sensor 110 in contact with the fluid 50.

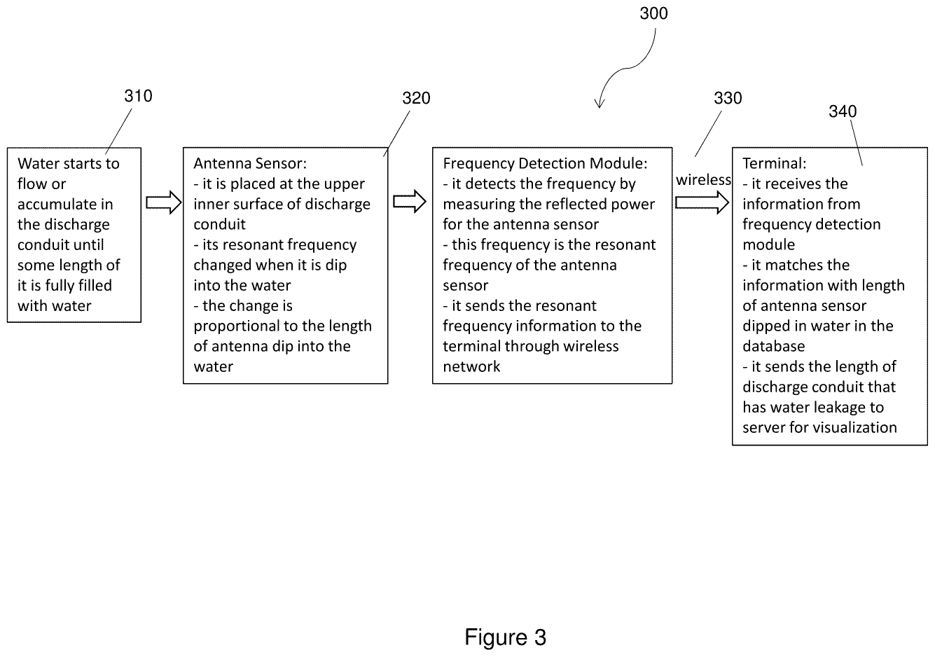

Another aspect of the invention relates to a method 300 of detecting the presence of fluid 50 will now be described with reference to FIG. 3. The method 300 comprises the steps of positioning a sensor 110 proximate to the fluid channel 10; detecting the resonate frequency generated by the sensor 110, the resonant frequency being variable in response to the amount of the fluid 50 proximate to the sensor 110; and determining the fluid leakage from the fluid channel 10 based on the detected resonate frequency of the sensor 110.

In one example embodiment in accordance with the present invention, it begins with step 310 where water starts to flow or accumulate in the discharge conduit 40 until some length of it is fully filled with water 50. Method 300 then proceeds to step 320 where the antenna sensor 110 is placed at the upper inner surface 42 of discharge conduit 40. The resonant frequency of the antenna sensor 110 changed when it is dip into the water 50. The change is proportional to the length of antenna 110 dip into the water 50.

In step 330, the frequency detection module 120 detects the frequency by measuring the reflected power for the antenna sensor 110. This frequency is the resonant frequency of the antenna sensor 110. The frequency detection module 120 sends the resonant frequency information to the terminal 130 through wireless network 132. Finally, in step 340, the terminal 130 receives the information from frequency detection module 120. The terminal 130 matches the information with length of antenna sensor 110 dipped in water 50 in the database. Finally, the terminal 130 sends the length of discharge conduit 40 that has water leakage to server 140 for visualization.

The step of preparing the analyzing module 140 may take place at any time before the step of identifying a change in the resonant frequency. To identify a change in the resonant frequency, the analyzing module 140 interprets the change in resonant frequency by comparing it with the reference data, thereby obtaining information of the change in the water level of the discharge conduit 40. The change in the water level of the discharge conduit 40 includes the detection of water leakage from the discharge conduit 40 or water level exceeding the safety threshold

By reason of the sensor 110 having a relatively small and thin form factor, the fluid detection apparatus 100 is particularly suitable for use in at locations where the boundary adjacent to the discharge conduit 40 is thin.

Advantageously, two or more identical fluid detection apparatus 100 with their respective sensor 110 and detector module 120 may be arranged at intervals across the two sides of the discharge conduit 40, all being connected to the same Long Range (LoRa) wireless network as the receiving module 130, which is in turn in LTE wireless communication 132 with the analyzing module 140 for continuous and automated detection. This allows for the detection of water leakage from the discharge conduit 40 in multiple locations across a wider area of the hill. The receiving module 130 is installed with an LTE (Long-Term Evolution) communication module for mobile communication with the analyzing server 140. A mobile phone running an appropriate app is able to communicate with the analyzing server 140 for at least monitoring the status of the water leakage from the discharge conduit 40.

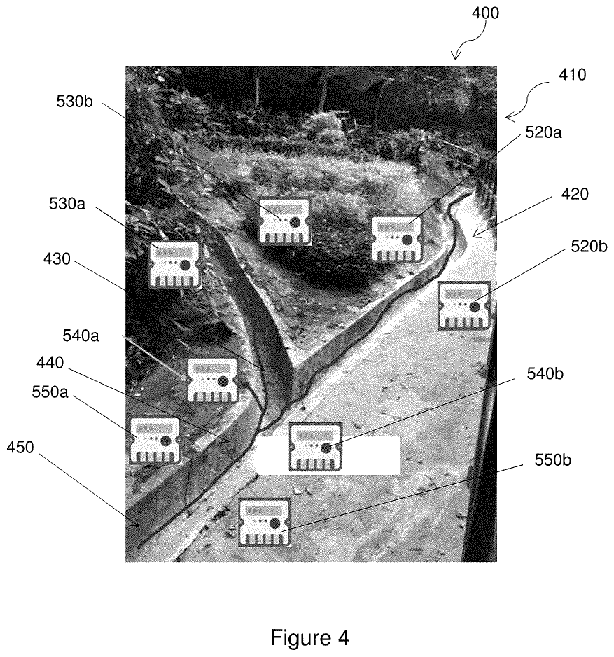

With reference finally to FIG. 4, there is shown yet another embodiment of a fluid detection system 400 for detecting water leakage from a lengthy fluid channel 410. The fluid detection system 400 may include multiple fluid detection apparatus for detecting the water leakage along multiple section of the fluid channel 410. Each of the fluid detection apparatus may be identical to the arrangement of the fluid detection apparatus 100 as exemplified in FIGS. 1 and 2.

In this fluid channel 410, the smaller drainage conduits 420, 430 collect the rainwater from the uphill and converge at the upstream 440 of the main drainage conduit. The water is further diverted via a sloped channel to a water storage tank (not shown) via the downstream 450 of the main drainage conduit. In some scenarios, a portion of the fluid channel 410 may be trapped by some obstacles e.g., waste and obstruct the water flow of a particular section of the fluid channel 410. However, even a small section of the fluid channel 410 is obstructed would be sufficient to contribute to the overflow of water in the fluid channel 410 and inevitably causes the water leakage from the fluid channel 410.

The fluid detection system 400 may include multiple pairs of fluid detection apparatus along the fluid channel 410 each positioned on the two opposite sides adjacent to the drainage conduits 420 to 450. The sensor in each of the fluid detection apparatus may generate a resonant frequency and the detector module in each of the fluid detection apparatus may detect the generated resonant frequency so as to detect the water leakage occurring in the corresponding section of the fluid channel 410.

For instance, a first pair of fluid detection apparatus 520a, 520b is positioned on the two opposite sides adjacent to the first discharge conduit 420 to detect the water leakage from the first discharge conduit 420. A second pair of fluid detection apparatus 530a, 530b is positioned on the two opposite sides adjacent to the second discharge conduit 430 to detect the water leakage from the second discharge conduit 430. As the first and second smaller drainage conduits 420, 430 converge at the upstream 440 of the main drainage conduit, there is also provided a third pair of fluid detection apparatus 540a, 540b on the two opposite sides adjacent to the upstream 440 of the main drainage conduit to detect the water leakage from the converging point. Finally, there is also provided a fourth pair of fluid detection apparatus 550a, 550b on the two opposite sides adjacent to the downstream 450 of the main drainage conduit to detect the water leakage from the downstream 450.

Each of the pairs of the detector module are in signal communication with a common receiving module so as to receive the signal data representing the water leakage from a corresponding section of the fluid channel 410. The receiving module may consolidate all the detected resonant frequencies and transfer the consolidated information in the form of a data packet to a common analyzing module. The analyzing module may parse the data packet and analyses the corresponding water leakage of the fluid channel 410. Advantageously, the analyzing module may graphically represent the magnitude of the water leakage at each reference point along the fluid channel 410 and the overall water leakage of the fluid channel 410.

While example embodiments of the present invention describe the application of the fluid detection apparatus in the field of water leakage detection, it may also be applied in other various technical fields. For instance, the fluid detection apparatus may be applied in the water leakage detection of the pipeline and in particular to the sensing of the water leakage from the pipes on the outside wall of a building or between concrete walls which may not be accessible by an inspector.

On the other hand, the fluid detection apparatus may also be applied in other applications where the presence of water is intended. For instance, the fluid detection apparatus may be applied in a wastewater treatment plant or a chemical plant of e.g., bleach water and in particular to the sensing of the presence of chemical fluid within the connecting pipes.

The invention has been given by way of example only, and various other modifications of and/or alterations to the described embodiment may be made by persons skilled in the art without departing from the scope of the invention as specified in the appended claims. It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A fluid detection apparatus for detecting the presence of fluid, comprising:
a sensor arranged to resonate at a resonant frequency;
a detector module arranged to detect the resonant frequency of the sensor;
wherein the resonate frequency of the sensor is variable in response to the amount of the fluid proximate to the sensor.

2. A fluid detection apparatus in accordance with claim 1, wherein the change in the resonate frequency is proportional to surface area of the sensor in contact with the fluid.

3. A fluid detection apparatus in accordance with claim 2, wherein the sensor includes a predetermined length and the change in the resonate frequency is proportional to the length of the sensor in contact with the fluid.

4. A fluid detection apparatus in accordance with claim 1, wherein the sensor is extended from the detector module.

5. A fluid detection apparatus in accordance with claim 1, wherein the detector module is fluidly isolated from the fluid channel.

6. A fluid detection apparatus in accordance with claim 1, wherein the resonate frequency detected by the detector module is indicative of fluid leakage from a fluid channel.

7. A fluid detection apparatus in accordance with claim 6, wherein the detector module is arranged to generate one or more information output associated with the fluid leakage from the fluid channel.

8. A fluid detection apparatus in accordance with claim 7, further including a receiving module in signal communication with the detector module thereby receiving information output associated with the fluid leakage from the fluid channel.

9. A fluid detection apparatus in accordance with claim 8, wherein the receiving module in wireless communication with the detector module.

10. A fluid detection apparatus in accordance with claim 8, wherein the receiving module further comprises a database storing a plurality of reference dataset correlating the level of fluid leakage to various resonate frequencies.

11. A fluid detection apparatus in accordance with claim 8, wherein the receiving module further comprises a solar panel arranged to harvest solar energy thereby supplying power to the analyzing module.

12. A fluid detection apparatus in accordance with claim 8, further including an analyzing module in signal communication with the receiving module thereby interpreting the information output associated with the fluid leakage in the fluid channel.

13. A fluid detection apparatus in accordance with claim 12, wherein the analyzing module is in LTE communication with the receiving module.

14. A fluid detection apparatus in accordance with claim 1, further comprising a housing for containing at least one of the sensor and the detector module.

15. A fluid detection apparatus in accordance with claim 1, wherein the sensor comprises an antenna sensor.

16. A fluid detection apparatus in accordance with claim 15, wherein the antenna sensor comprises a RF antenna.

17. A fluid detection apparatus in accordance with claim 1, wherein the detector module is located proximate to the sensor thereby measuring the reflected power of the antenna sensor.

18. A fluid detection apparatus in accordance with claim 17, wherein the detector module comprises an antenna circuit arranged to detect the resonance frequency of the antenna sensor.

19. A fluid detection apparatus in accordance with claim 1, wherein the fluid channel is a discharge conduit.

20. A method of detecting the presence of fluid, comprising the steps of:
positioning a sensor proximate to the fluid channel;
detecting the resonate frequency generated by the sensor, the resonant frequency being variable in response to the amount of the fluid proximate to the sensor; and
determining the fluid leakage from the fluid channel based on the detected resonate frequency of the sensor.
